(19) United States
(12) Patent Application Publication
(10) Pub. No.: US 2025/0307108 A1
(43) Pub. Date: Oct. 2, 2025

(54) ENHANCEMENT EVENT DETERMINATION AND USE IN SYSTEM MONITORING

(71) Applicant: BMC Software, Inc., Houston, TX (US)

(72) Inventors: Vikram Niranjan Kamate, Pune (IN); Jatinkumar Jayantkumar Parikh, Pune (IN); Rakesh Rohidas Vende, Pune (IN); Brendan Farrell, Austin, TX (US)

(21) Appl. No.: 18/622,305

(22) Filed: Mar. 29, 2024

(51) Int. Cl. G06F 11/34; G06F 11/30

(52) U.S. Cl. CPC G06F 11/3447; G06F 11/3072

(57) ABSTRACT

A stream of performance metrics characterizing a first component within a first topology of a technology landscape may be monitored. An enhancement event in the stream of performance metrics may be determined. The enhancement event may be determined to be caused by an action performed with respect to the first component within the first topology. A change detection service characterizing the technology landscape may be queried, using the first topology and the action. A second topology of the technology landscape may be received from the change detection service and in response to the query. The action may thus be with respect to a second component of the second topology.

### TECHNICAL FIELD

This description relates to system monitoring.

### BACKGROUND

Many companies and other entities have extensive technology landscapes that include numerous Information Technology (IT) assets, including hardware and software. It is often required for such assets to perform at high levels of speed and reliability, while still operating in an efficient manner. For example, various types of computer systems are used by many entities to execute mission critical applications and high volumes of data processing, across many different workstations and peripherals.

Various types of system monitoring methods are used to detect, predict, prevent, mitigate, or cure system faults that might otherwise disrupt or prevent monitored IT assets from achieving system goals. For example, it is possible to monitor various types of performance metrics characterizing aspects of system performance. When monitored values of the detected performance metrics are scored as being outside of a predetermined range, the monitored values may be considered potentially indicative of a current or future system malfunction, and appropriate action may be taken.

### SUMMARY

According to one general aspect, a computer program product may be tangibly embodied on a non-transitory computer-readable storage medium and may include instructions. When executed by at least one computing device, the instructions may be configured to cause the at least one computing device to process a stream of performance metrics characterizing a first component within a first topology of a technology landscape and detect an enhancement event in the stream of performance metrics. When executed by at least one computing device, the instructions may be configured to cause the at least one computing device to determine that the enhancement event was caused by an action performed with respect to the first component within the first topology and query a change detection service characterizing the technology landscape, using the first topology and the action. When executed by at least one computing device, the instructions may be configured to cause the at least one computing device to receive, from the change detection service and in response to the query, a second topology of the technology landscape, and implement the action with respect to a second component of the second topology.

According to other general aspects, a computer-implemented method may perform the instructions of the computer program product. According to other general aspects, a system, such as a mainframe system or a distributed server system, may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a monitoring system with enhancement event determination and use.

FIG. 2 is a flowchart illustrating example operations of the monitoring system of FIG. 1.

FIG. 3 is a block diagram illustrating more detailed example implementation aspects of the system of FIG. 1.

FIG. 4 is a block diagram illustrating a process flow for identifying and validating an enhancement event.

FIG. 5 is a first graph illustrating an example performance improvement indicating a candidate enhancement event.

FIG. 6 is a second graph illustrating an example performance improvement indicating a candidate enhancement event.

FIG. 7 is a graph illustrating an example weekly performance baseline.

FIG. 8 is a graph illustrating an example performance improvement indicating a candidate enhancement event.

FIG. 9 is a graph illustrating validation of the candidate enhancement event of FIG. 8 as an enhancement event.

FIG. 10 is a graph illustrating a second example weekly performance baseline.

FIG. 11 is a graph illustrating a second example performance improvement indicating a candidate enhancement event.

FIG. 12 is a graph illustrating exclusion of the candidate enhancement event of FIG. 11 as an enhancement event.

FIG. 13 is a block diagram illustrating an example implementation for propagating performance enhancements to additional monitored systems.

FIG. 14 is a block diagram illustrating detailed example implementations of the systems and methods of FIGS. 1-13.

### DETAILED DESCRIPTION

Described systems and techniques provide performance enhancements of monitored systems, even when the monitored systems are operating in a fully functional and non-anomalous manner. As a result, it is possible to improve the monitored systems in terms of, e.g., latency, speed, utilization, efficiency, or reliability, while minimizing the risk of experiencing or preventing system failures or malfunctions.

As referenced above, many existing monitoring systems provide varying levels of ability in detecting and reacting to anomalous system behaviors. For example, a monitored system may demonstrate a breach of a threshold for maximum allowable CPU utilization, memory usage, or response latency. The monitoring system, or related system, may then take responsive action, such as allocating one or more additional types of system resources in order to return the monitored system to a non-anomalous state.

In contrast, described techniques detect improvements in, or enhancements of, system performance, even when the monitored system is in a fully operational and non-anomalous state, and without requiring any prediction that the monitored system may be in danger of experiencing a predicted anomaly. Rather, described techniques detect system enhancements and then correlate the system enhancements with one or more corresponding system update(s) or other action(s). After validating that the action(s) was causative of the enhancement, the correlated action may be propagated to other, similar systems, in order to provide similar performance enhancements to those systems, as well.

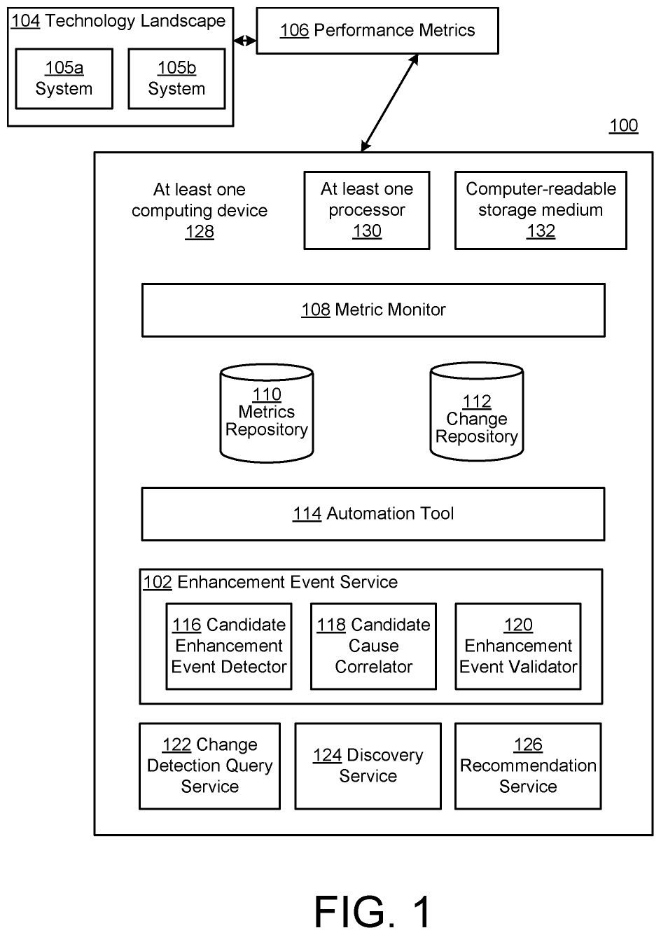

FIG. 1 is a block diagram of a monitoring system 100 with enhancement event determination and use. In FIG. 1, an enhancement event service 102 facilitates and provides automatic enhancement of systems that are already fully functional, operational, and/or non-anomalous, as described herein, to thereby provide improvements in efficiency, speed, and/or reliability to the enhanced systems.

In FIG. 1, a technology landscape 104 may represent any suitable source of performance metrics 106 that may be processed for enhancements using the monitoring system 100. For example, in some embodiments the technology landscape 104 may represent any computing environment of an enterprise or organization conducting enterprise network-based IT transactions or interactions. The technology landscape 104, however, is not limited to such environments. For example, the technology landscape 104 may include many types of network environments, such as network administration of a private network of an organization.

Technology landscape 104 may also represent scenarios in which sensors, such as internet of things devices (IoT) are used to monitor environmental conditions and report on corresponding status information (e.g., with respect to patients in a healthcare setting, working conditions of manufacturing equipment or other types of machinery in many other industrial settings (including the oil, gas, or energy industry), or working conditions of banking equipment, such as automated transaction machines (ATMs)). In some cases, the technology landscape 104 may include, or reference, an individual IT component, such as a laptop or desktop computer or a server. In some cases, the technology landscape 104 may include, or reference, a mainframe computing environment.

In the example of FIG. 1, the technology landscape 104 includes a system 105a and a system 105b. The systems 105a, 105b may be, e.g., components or systems that are implemented in different geographical regions, or in different parts of a corporations organizational structure. The systems 105a, 105b may each represent a combination of components or subsystems that may themselves be geographically distributed. Thus, the systems 105a, 105b should be broadly understood to represent any portion of the technology landscape 104, from a single component to a wide area network of components.

The systems 105a and 105b may each be associated with a corresponding system topology. That is, for example, the system 105a may exhibit a first topology characterized by a plurality of nodes and components (which may be hardware or software) and connections or relationships therebetween. The system 105a may exhibit a first topology, while the system 105b may exhibit a second topology, both of which may be part of a larger topology of the technology landscape 104, as a whole.

The performance metrics 106 may represent any corresponding type(s) of data that is captured and reported, particularly in an ongoing, dynamic fashion, and can be for a potentially large number of conditions being monitored. For example, in a setting of online sales or other business transactions, the performance metrics 106 may characterize a condition of many servers being used. In a healthcare setting, the performance metrics 106 may characterize either a condition of patients being monitored or a condition of IoT sensors being used to perform such monitoring. Similarly, the performance metrics 106 may be characterizing the condition of machines being monitored or of IoT sensors performing monitoring in manufacturing, industrial, energy, healthcare, or financial settings.

In many of the examples below, which may occur in networking environments, the performance metrics 106 may include Key Performance Indicators (KPIs). In many implementations, the performance metrics 106 represent a real-time or near real-time stream of data that is frequently or constantly being received with respect to the technology landscape 104. For example, the performance metrics 106 may be considered to be received within defined time windows, such as every second, every minute, or every hour.

In the present description, the term KPI should be understood broadly to represent or include any measurable value that can be used to indicate a past, present, or future condition, or enable an inference of a past, present, or future condition with respect to a measured context (including, e.g., the example contexts referenced below). KPIs are often selected and defined with respect to an intended goal or objective, such as maintaining an operational status of a network, or providing a desired level of service to a user.

For example, KPIs may include a percentage of central processing unit (CPU) resources in use at a given time, an amount of memory in use, or data transfer rates or volumes between system components. In a given IT system, the system may have hundreds or even thousands of KPIs that measure a wide range of performance aspects about the system and its operation. Consequently, the various KPIs may, for example, have values that are measured using different scales, ranges, thresholds, and/or units of measurement.

In FIG. 1, a metric monitor 108 receives the performance metrics 106 over time, e.g., in real time. The performance metrics 106 may be monitored in a manner that is particular to the type of underlying IT asset or resource being monitored. For example, received values (and value ranges) and associated units of measurement may vary widely, depending on whether, for example, an underlying resource includes processing resources, memory resources, or network resources (e.g., related to network bandwidth, or latency).

Additionally, values of performance metrics 106 may vary over time, based on a large number of factors. For example, values of performance metric 106 may vary based on time of day, time of week, or time of year. Performance metric values may vary based on many other contextual factors, such as underlying operations or seasonality of a business or other organization deploying the technology landscape 104.

Various systems may identify many different types of performance metrics for corresponding system assets. Although widely varying in type, a common scoring system across all of the performance metrics 106 may be used for all such performance metrics 106 for ease and consistency of comparison of current operating conditions (e.g., anomalies). In other examples, performance metrics 106 may be measured in units that are particular to the metric being measured (e.g., latency may be measured in seconds, or CPU utilization may be measured in numbers of processing cycles).

To assist users monitoring KPIs and other performance metrics 106, and to visually elevate awareness of specific scores, other schemes may be used, such as colors, graphics, textures, or other visual techniques may be used in the context of a system status dashboard. For example, in such a system dashboard, scores within defined ranges may be colored green to indicate a satisfactory condition, yellow to indicate a cautionary condition, and red to indicate an anomaly. Consequently, particular metrics or underlying systems that are operating in a fully functional state, e.g., within defined performance ranges and/or not exceeding defined anomaly thresholds, may be referred to as being ‘green.’

A metrics repository 110 may be used to store some or all of the performance metrics 106. For example, the metrics repository 110 may automatically store a most-recent set of performance metrics 106 received within a defined time window. Metric values determined not to be useful following an end of the defined time window may be archived, or deleted, to conserve system resources.

In the present description, an event may refer generally to any one or more performance metrics of the metric repository 110 that are indicative of a notable operation or occurrence with respect to the technology landscape 104. For example, such an event may correspond to a KPI or performance metric 106 score that goes outside of a pre-defined range, or exceeds a defined threshold.

An event may include a combination of KPIs that exhibit an effect on, or aspect of, the technology landscape 104. An event may occur at a point in time, or may be defined with respect to a trend or pattern that occurs over a period of time.

An event may include an action taken by an administrator or other authorized user of the technology landscape 104. An event may refer to an effect of an action taken by a customer, vendor, or partner in the context of the technology landscape 104. An event may also refer to a malfunction of any one or more components of the technology landscape 104.

An event may be stored using the metrics repository 110. Each event may be stored with related event information, such as a context or current state of a relevant component(s), e.g., connected components.

As noted above, conventional systems may use KPIs or other performance metrics 106, and associated scoring or evaluation systems, to detect and track events that cause, or are likely to cause, anomalous or other undesired results within the technology landscape 104. Such events may be referred to as anomaly events. For example, such anomaly events may include a component or system crash, an excessive latency or memory usage, or any other occurrence that may impart a need for corrective action to return or maintain the technology landscape 104 in for example, a “green” or non-anomalous state.

In FIG. 1, in contrast, and as described in detail, herein, the enhancement event service 102 may be configured to identify, characterize, validate, and propagate enhancement events of the metrics repository 110 that improve the functioning of already functional (e.g., in the “green” state) components of the technology landscape 104. For example, the enhancement event service 102 may detect an enhancement event with respect to the system 105a of the technology landscape 104, and then propagate the enhancement event to the system 105b.

As a result, for example, system improvements may be provided, without requiring or risking system malfunctions that may inconvenience users or result in other undesired outcomes. Additionally, system downtime may be avoided or minimized. Moreover, by improving performances of already-functional components, the enhancement event service 102 may effectively provide additional system slack or buffering with respect to existing event thresholds. Put another way, a system tolerance may be raised. In some cases, existing event thresholds or scoring systems may be updated to reflect such improvements.

In order to identify potential enhancement events, a change repository 112 may be maintained that tracks changes made to the technology landscape 104. For example, such changes may include manual or automated changes to various configuration parameters of the technology landscape 104. In other examples, such changes may include additions, subtractions, or modifications made with respect to existing resources of the technology landscape 104.

Such changes may be planned or unplanned. Such changes may be ad hoc or part of a larger maintenance or upgrade process(es) associated with the technology landscape 104. Such changes may be implemented for a defined purpose, but may have unplanned or unintended consequences within the technology landscape 104, where such consequences may be positive and/or negative with respect to a performance of the technology landscape 104.

Stored changes may also include, or reflect, usage changes that occur during usage of the technology landscape 104. For example, hardware usage of some system resources may increase in conjunction with rollout of a new feature or service used by customers. Additional examples of changes that may be stored using the change repository 112 are provided below, or would be apparent.

An automation tool 114 refers to one or more tools designed to implement and enact at least some of the changes stored using the change repository 112. For example, the automation tool 114 may be configured to automatically rollout system updates or upgrades, or to automatically deploy new software. In other examples, the automation tool 114 may be configured to implement a specific set of steps specified by an administrator with respect to changes made to the technology landscape 104. Consequently, it will be appreciated that at least some of the changes stored within the change repository 112 may be captured in conjunction with (e.g., as a result of) operations of the automation tool 114.

The enhancement event service 102 may be configured to monitor and analyze metrics in the metrics repository 110 in conjunction with changes in the change repository 112 to determine enhancements that occur in one component or system of the technology landscape 104 that may be propagated to other components or systems of the technology landscape 104. As a result, the enhancement event service 102 may provide the types of operational improvements in the technology landscape 104 described herein.

For example, the enhancement event service 102 may include a candidate enhancement event detector 116 that is configured to identify events within the metrics repository 110 that may represent enhancement events. For example, the candidate enhancement event detector 116 may monitor a moving average of one or more metric values, and may detect any improvement in the monitored metric value(s) that exceed an enhancement threshold. Such an improvement may then be isolated as a candidate enhancement event.

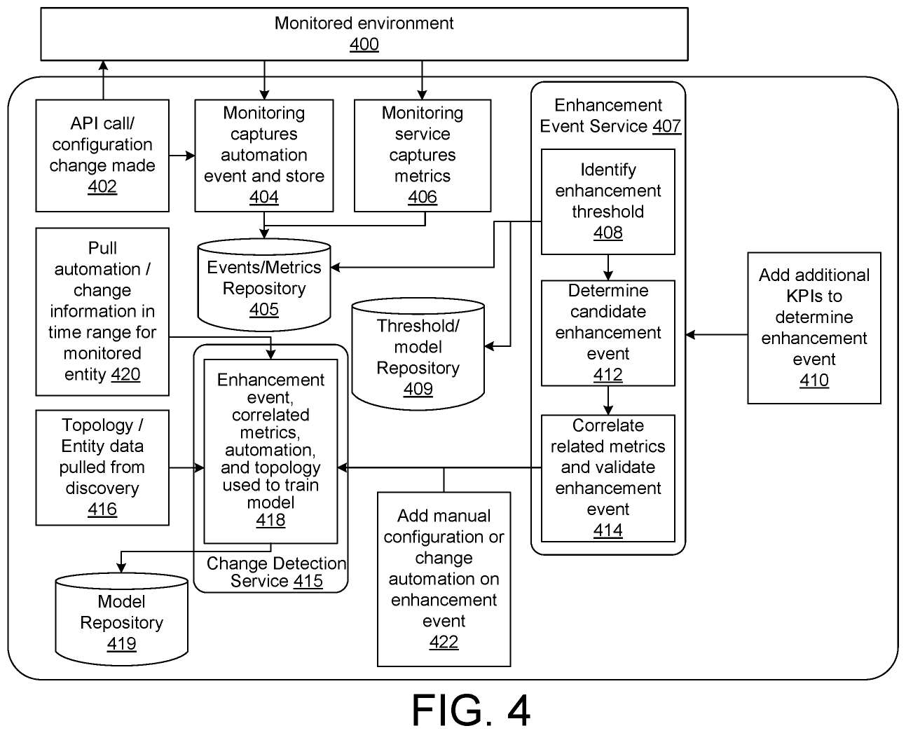

For example, as described in detail below with respect to FIGS. 4-12, an improvement in a monitored metric value may include a decrease in CPU utilization or memory usage, or a decrease in a query response time. As also described herein, such improvements may or may not be determinable as being caused by a corresponding change in the change repository 112. Moreover, it may or may not be possible or practical to propagate such improvements within the technology landscape 104.

A candidate cause correlator 118 may be configured to determine, for each candidate enhancement event, one or more potential causes. For example, multiple changes in the change repository 112 may have occurred in a time period leading up to a time of the candidate enhancement event being evaluated, one or more of which may have had a causal effect on the candidate enhancement event. In other examples, various metrics or events in the metrics repository 110 may also have a causal effect on the candidate enhancement event(s).

As described in detail, below, various algorithms or machine learning (ML) models may be used to correlate relevant changes and events with each candidate enhancement event. For example, a time series regression algorithm, such as a vector autoregression algorithm, may be used.

An enhancement event validator 120 may be configured to validate a candidate enhancement event from the candidate enhancement event detector 116 against the identified candidate causes of the candidate cause correlator 118 to identify each enhancement event. For example, some candidate causes may be ruled out as being correlated rather than causal. Other candidate causes may be related to changes in usage on the part of one or more users of the technology landscape 104, rather than to an implemented change of the change repository 112. Still other candidate causes may be determined to be impossible or impractical to repeat or propagate within the technology landscape 104, which may also lead to exclusion of a candidate enhancement event and associated cause and/or change from further processing.

A change detection query service 122 may be configured to utilize validated enhancement events and related metadata to facilitate identification of candidate components or systems within the technology landscape 104 to which each validated enhancement event might be propagated. In other words, the change detection query service 122 provides a query/response service that is capable of inputting characteristics of a first enhancement event and associated context and then outputting one or more candidate contexts in which the same or similar enhancement event may feasibly be implemented, in order to potentially obtain the same or similar performance enhancement(s) in the one or more additional contexts.

For example, a validated enhancement event and associated causal change may be identified by the enhancement event service 102 with respect to the system 105a of the technology landscape 104. A discovery service 124 may be configured to investigate the system 105a to determine metadata relevant to the validated enhancement event. For example, such metadata may include a local topology of the system 105a, various resource characteristics (e.g., quantity of available memory or processing power available), or a history (or future planned changes) of implemented changes within the system 105a.

The discovery service 124 may be implemented using one or more existing discovery services used, for example, by the types of conventional anomaly detection tools referenced above. For example, many such discovery services are available for use in the context of characterizing an anomaly and then performing associated system discovery to analyze and remediate such an anomaly.

In the context of FIG. 1, however, the discovery service 124 may be utilized to characterize both the system in which the validated enhancement event occurs, such as the system 105a, as well as other potential systems to which the validated enhancement event might reasonably be propagated, such as the system 105b. For example, the discovery service 124 may perform discovery on other areas of the technology landscape 104 to determine a topology and other metadata of the system 105b.

Outputs of the discovery service 124 may thus be used by the change detection query service 122 to receive a validated enhancement event and associated enhancement metadata as a query, and then output one or more candidate components or systems to which the validated enhancement event might be propagated. The change detection query service 122 may also output characteristics of the identified components and/or systems that may be relevant in determining whether to proceed with propagating the validated enhancement event.

Accordingly, a recommendation service 126 may receive candidate enhancement targets from the change detection query service 122 and generate one or more recommendations for enhancement event propagation. For example, the recommendation service 126 may characterize a type or extent of a match between the validated enhancement event and each candidate enhancement target identified as potentially receiving the validated enhancement event.

The recommendation service 126 may be configured to evaluate various other factors related to implementing a validated enhancement event in the context of each identified candidate enhancement target. For example, there may be a cost or consequence associated with deploying the validated enhancement event in the context of a particular candidate enhancement target. For example, a particular candidate enhancement target may include contextual factors that might inhibit an efficacy of the validated enhancement event in that context.

Once a candidate enhancement event target (such as the system 105b) is identified as a recommended enhancement event target, the automation tool 114 may be configured to implement the causal change that originally led to the detected performance enhancement, as determined by the enhancement event service 102, in the context of the target system. In this way, a single validated enhancement event may be automatically propagated to one or more target systems, and associated performance enhancement may be obtained wherever feasible, practical, or desirable within the technology landscape 104.

In FIG. 1, the enhancement event service 102 is illustrated as being implemented using at least one computing device 128, including at least one processor 130, and a non-transitory computer-readable storage medium 132. That is, the non-transitory computer-readable storage medium 132 may store instructions that, when executed by the at least one processor 130, cause the at least one computing device 128 to provide the functionalities of the enhancement event service 102 and related functionalities.

For example, the at least one computing device 128 may represent one or more servers. For example, the at least one computing device 128 may be implemented as two or more servers in communications with one another over a network. Accordingly, the enhancement event service 102, the change detection query service 122, and the recommendation service 126 may be implemented using separate devices in communication with one another. In other implementations, however, although the enhancement event service 102 is illustrated separately from the change detection query service 122 and the recommendation service 126, it will be appreciated that some or all of the respective functionalities of the enhancement event service 102, the change detection query service 122, and/or the recommendation service 126 may be implemented partially or completely in one another, e.g., as a single component.

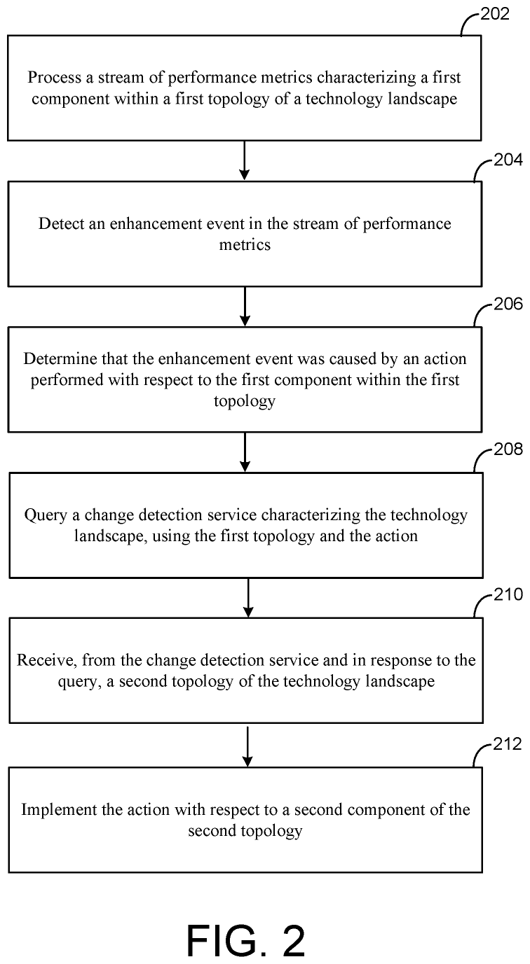

FIG. 2 is a flowchart illustrating example operations of the system of FIG. 1. In the example of FIG. 2, operations are illustrated as separate, sequential operations. In various implementations, however, the illustrated operations may include sub-operations, may be performed in a different order, may include alternative or additional operations, or may omit one or more operations. Further, in all such implementations, included operations may be performed in an iterative, looped, nested, or branched fashion.

In FIG. 2, a stream of performance metrics characterizing a first component within a first topology of a technology landscape may be processed (202). For example, the candidate enhancement event detector 116 may process performance metrics of the technology landscape 104 obtained from the metric monitor 108 and/or the metrics repository 110. The first component may correspond, e.g., to the system 105a of FIG. 1.

An enhancement event in the stream of performance metrics may be detected (204). For example, the candidate enhancement event detector 116 may detect an improvement in a metric that exceeds an enhancement threshold for that metric.

The enhancement event may be determined to be caused by an action performed with respect to the first component within the first topology (206). For example, the candidate cause correlator 118 may be configured to identify potential enhancement event causes within the change repository 112 that occurred in proximity to a corresponding candidate enhancement event identified by the candidate enhancement event detector 116 and with respect to the system 105a. The enhancement event validator 120 may be configured to validate that a candidate cause should be associated with the corresponding candidate enhancement event as an enhancement cause/event pair, and that the enhancement event is propagatable within the technology landscape 104.

A change detection service characterizing the technology landscape 104 may be queried, using the first topology and the action (208). For example, the change detection query service 122 may be queried using the system 105a and the action determined to be causative of the relative performance enhancement. Other query parameters may be used, as well. For example, resources needed or available to implement the relevant action may be specified.

A second topology of the technology landscape 104 may be received from the change detection service and in response to the query (210). For example, a topology of the system 105b may be identified by the change detection query service 122, thereby identifying the system 105b as a candidate target system for implementing the identified action to potentially obtain a corresponding performance enhancement.

The action may then be implemented with respect to a second component of the second topology (212). For example, the candidate enhancement target system 105b may be recommended for receiving the relevant causal action at one or more components thereof, by the recommendation service 126.

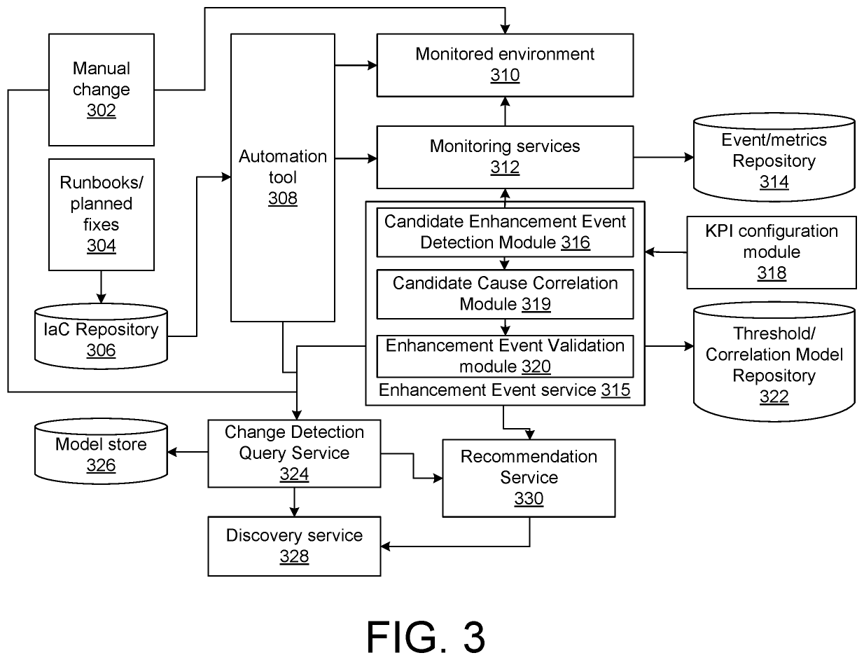

FIG. 3 is a block diagram illustrating more detailed example implementation aspects of the system of FIG. 1. As referenced above with respect to FIG. 1, there are multiple sources of changes that may be present with respect to the technology landscape 104 and stored within the change repository 112. By way of further example of sources of such system changes, FIG. 3 illustrates manual change 302, runbooks/planned fixes 304, and Infrastructure as Code (IaC) repository 306.

For example, manual change 302 may refer to a manual change performed through an application program interface or console to fix an issue that is reported by a user or observed by monitoring. For example, such manual changes may include an action such as vertical or horizontal scaling or configuration changes.

Runbooks/planned fixes 304 refers to more planned or scheduled changes, rather than reactions to more specific events. In addition to potentially being based on a runbook, such changes may include triggered automation or any related additional code change.

The IaC repository 306 may be used to store either configuration data or additional automation scripts. Such data and/or scripts may be used by various automation and/or deployment tools.

In FIG. 3, an automation tool 308 provides an example of such tools, as well as an instance of the automation tool 114 of FIG. 1. The automation tool 308, as shown, may be configured to implement and deploy configuration data and/or automation scripts from the IaC repository 306 to a monitored environment 310, and may be further configured to update one or more monitoring services 312 with respect to implemented changes and other actions taken.

The monitored environment 310, as an example of some or all of the technology landscape 104 of FIG. 1, may include any set of resources monitored, e.g., in one or more data centers, and that is generating, e.g., metrics, events, logs, and traces that are captured and/or characterized by the monitoring services 312 and stored within an event/metrics repository 314. In other words, in the example of FIG. 3, the events/metrics repository 314 may be understood to store all of the contents of the metrics repository 110 and the change repository 112 of FIG. 1, as well as enhancement events, as described below. In other words, for example, the events/metrics repository 314 may store metrics and events captured by the monitoring services 312, change events implemented by the automation tool 308, enhancement events provided by an enhancement event service 315, and relationships between these various types and/or quantities of data.

The enhancement event service 315 includes a candidate enhancement event detection module 316, which may be configured to use settings from a KPI configuration module 318 to determine a metric baseline to use in detecting candidate enhancement events that deviate beyond an enhancement event threshold, relative to the metric baseline.

For example, as described and illustrated in more detail, below, with respect to FIGS. 3 and 4, the metric baseline may be established as a moving weekly average of a particular KPI being monitored, with weekly-daily seasonality. Such a metric baseline may be established with respect to many different KPIs or groups of KPIs stored using the KPI configuration module 318.

For example, the KPI configuration module 318 may store different, preconfigured or standard KPIs for various different types of services, components, or systems. Some KPIs may be generic to many different underlying components, such as, e.g., response time or resource utilization. Other KPIs may be specific to a component or type of component. Some KPIs may be configurable by an owner, administrator, or end user.

Additionally, in the implementation of FIG. 3, other new metric types may be configured and stored with corresponding metrics in the event/metrics repository 314. For example, a metric type of ‘key-causal’, also referred to as ‘causal’, may be associated with a subset of KPIs or other metrics. Such metrics are identified as having direct or indirect causation of an enhancement event in a manner that is repeatable in, and able to be propagated to, other components or systems within the monitored environment 310. Such metrics may characterize, for example, specific change events or change event types of changes implemented by the automation tool 308 or by a manual change 302 within the monitored environment 310.

In contrast, another type of metric that may be characterized is referred to herein as a ‘false-causal’ or ‘false positive’ metric. Such metrics may relate to, or characterize, performance improvements within the monitored environment 310, but that are not repeatable propagatable within the monitored environment 310. For example, such metrics may relate to changes in user activity or other external factors that are not controllable or implementable by the automation tool 308.

A candidate cause correlation module 319 may be configured to evaluate candidate enhancement events from the candidate enhancement event detection module 316, to identify correlated metrics that may have, or did, cause the candidate enhancement event being evaluated. For example, the candidate cause correlation model may evaluate potentially relevant metrics within a defined or determined time window prior to occurrence of the candidate enhancement event.

In more specific examples, described in more detail, below, the candidate cause correlation module 319 may implement a trained machine learning (ML) model using a time series regression algorithm, e.g., the vector autoregression algorithm. For example, the vector autoregression algorithm may be used to identify and correlate all the key-causal and false-causal metrics which could have caused the candidate enhancement event being evaluated. Other types of correlation algorithms may be used as well, e.g., the Pearson Correlation, and are not described here in detail.

A threshold/correlation model repository 322 may be used to store any correlation model(s) used by the candidate cause correlation module 319 to evaluate candidate enhancement events to determine candidate causes. The threshold/correlation model repository 322 may also be used to store any enhancement threshold(s) used by the candidate enhancement event detection module 316 to determine candidate enhancement events. For example, as described herein, such enhancement thresholds may be expressed as a percentage improvement in a measured metric, a rate of change of a measured metric, a duration of a measured improvement, or various other characteristics of improved performance, or combinations thereof. Such thresholds may be preconfigured for individual metrics or types of metrics, or may be determined dynamically during candidate enhancement event evaluation.

An enhancement event validation module 320 may be configured to input candidate enhancement events and candidate causes, along with any relevant data from the threshold/correlation model repository 322 and/or the event/metrics repository 314, and determine whether each candidate enhancement event can be validated as being an enhancement event.

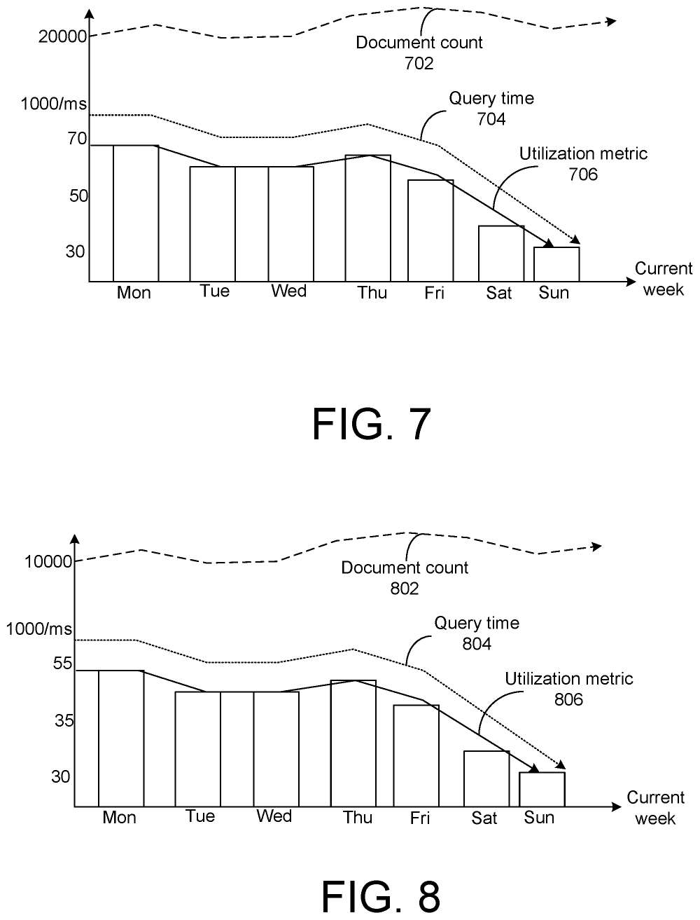

For example, the enhancement event validation module 320 may evaluate a candidate enhancement event associated with both a key-causal metric and a false-causal metric, to determine whether the key-causal metric was causative of a sufficient portion of a detected performance improvement. Other examples of enhancement event validation are provided below, e.g., with respect to FIGS. 7-12.

A change detection query service 324 may be configured to train a ML model to respond to queries based on, e.g., enhancement events, automation events (changes), change requests, metric patterns, and discovered topology information. The resulting model(s) may be stored in a model store 326.

A discovery service 328 may be configured to interrogate the monitored environment 310 to obtain information about included components, systems, or other entities, along with related topology information. Such topology information may be used to further characterize a validated enhancement event, e.g., to discover and describe a context in which the validated enhancement event occurred. Such topology information may further be used to match a validated enhancement event with a separate, second topology in which the validated enhancement event may be repeated by implementing an underlying change request.

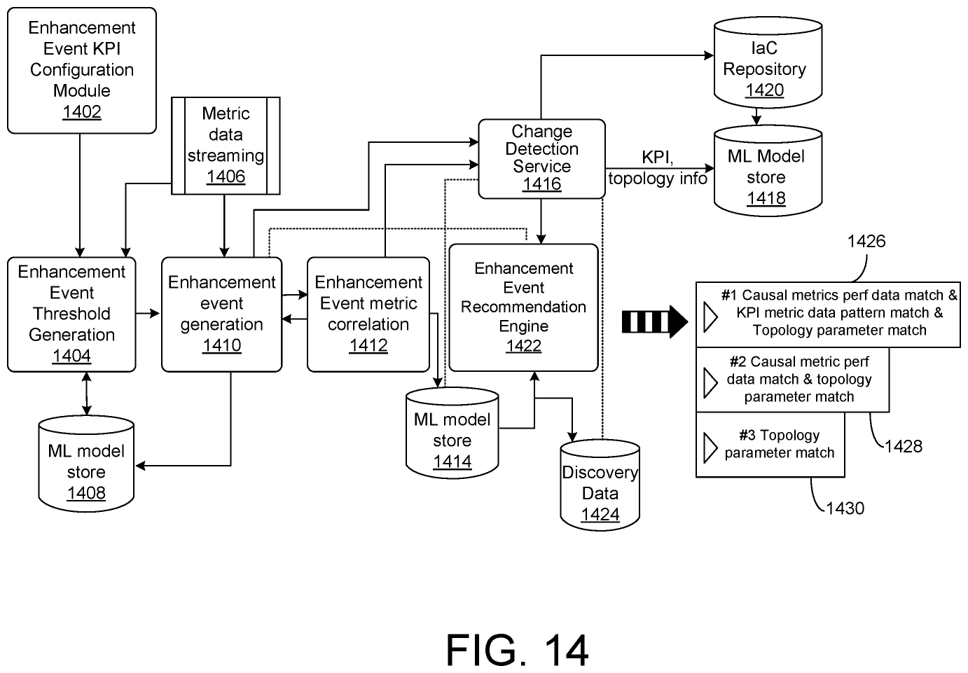

A recommendation service 330 may be configured to utilize, e.g., discovery information (e.g., discovered topology information), data from monitoring services, enhancement events, and outputs of the change detection model to make recommendations to apply changes to additional components, systems, and other entities within the monitored environment 310. For example, a change implemented in a first data center that causes an enhancement event may be recommended to be repeated in a second data center, based on a degree of structural and operational similarity of the two data centers. The recommendation service 330 may further characterize or rank recommendations, based, e.g., on a degree of similarity between the two or more systems (e.g., data centers) being evaluated, or on various other factors. Further details and examples related to the recommendation service 330 are provided below, e.g., with respect to FIGS. 13 and 14.

FIG. 4 is a block diagram illustrating a process flow for identifying and validating an enhancement event, using the system of FIG. 3. In the example of FIG. 4, an application program interface (API) call or configuration change is made (402) with respect to a monitored environment 400. For example, as described above, a change may be made to fix an issue, remediate an anomaly or alarm, or implement a scheduled update or upgrade. For example, a deployed service may be horizontally or vertically scaled, or a service may be configured in a desire manner, e.g., using the automation tool 308 of FIG. 3. Such changes are referred to in FIG. 4 as an ‘automation’, or ‘automation event.’

Monitoring (e.g., using the monitoring service(s) 312 of FIG. 3) may be implemented to capture and store the automation event (404). For example, the automation event may be stored with relevant details regarding the time frame of the automation event, relevant entity information, and relevant topology information. For example, relevant information may be captured using the discovery service 328 of FIG. 3, either at a prior time and/or concurrently with the automation event.

Various metrics for relevant KPIs may be captured by the monitoring service 406 (similar to the monitoring service(s) 312 of FIG. 3) for the monitored environment 400. For example, improvements in one or more metrics may be detected, such as reductions in CPU or memory utilization. Corresponding metric data may be stored in an events/metrics repository 405, similar to the events/metrics repository 314 of FIG. 3.

An enhancement event service 407, similar to the enhancement event service 315 of FIG. 3, may then identify a relevant enhancement threshold (408) from a threshold/model repository 409 (similar to the threshold correlation 408 model repository 322 of FIG. 3). Additional KPIs may be accessed to evaluate whether an enhancement event may have occurred 410, i.e., to determine a candidate enhancement event 412.

For example, in the example of a reduction of CPU utilization, a relevant enhancement threshold for CPU utilization may be identified that identifies a percentage or quantity of CPU reduction, and the current CPU utilization reduction may be compared to the threshold CPU utilization reduction. Therefore, an identified event that includes a CPU utilization reduction that meets the corresponding enhancement threshold may be identified as a candidate enhancement event. Related KPIs may be investigated to evaluate whether the detected event should be classified as a candidate enhancement event. For example, some metric improvements may be correlated with, or related to, improvements in other metrics. In other examples, additional KPIs may be related to, or indicative of, potential causal changes that may have led to the occurrence of the candidate enhancement event.

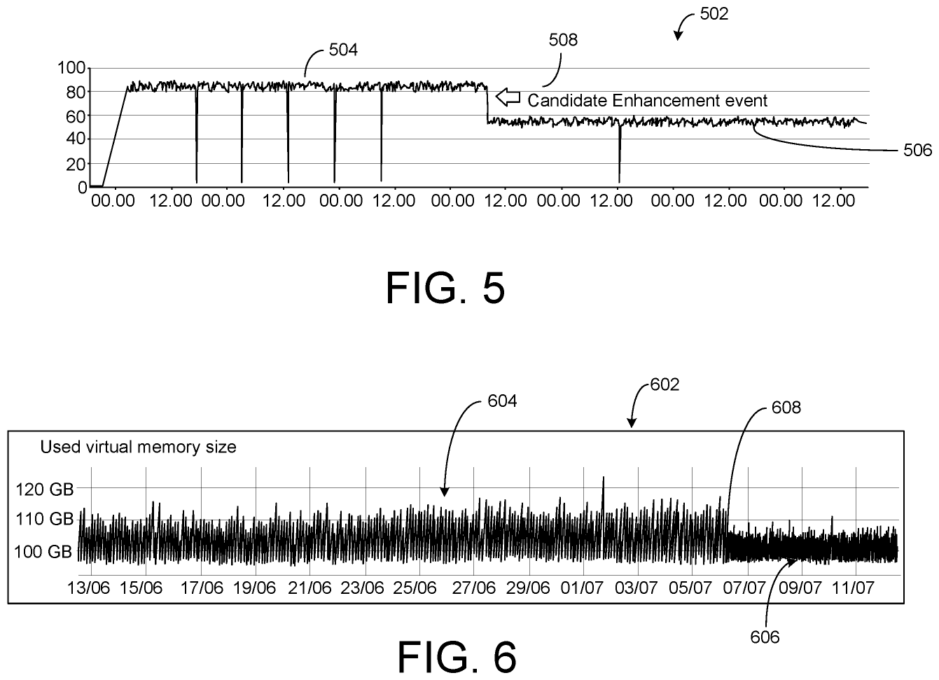

Additional examples of, and details related to, enhancement thresholds are described below, for example, with respect to FIGS. 5 and 6. In general, in some examples, KPIs and related metrics may be defined in conjunction with related, corresponding monitored entities. For example, there may be default metrics that apply to many different entities, such as resource utilization (e.g., CPU, memory, or disk) and response times. Other KPIs may be entity specific, such as an indexing latency of a search service.

The candidate enhancement event may then be correlated with, and validated against, candidate causes 414. For example, once an enhancement event threshold for a KPI is met, vector autoregression may be used to identify and correlate key-causal and false-causal metrics that may have triggered, or otherwise been associated with, the event. If a key-causal metric is validated, a confirmation or validation of the enhancement event may be generated.

To obtain information used for subsequent recommendations, a change detection service 415 may be configured, in conjunction with a discovery service such as the discovery service 328 of FIG. 3, to retrieve topology and entity data information 416. Such information may include, for example, an entity type, entity name, business service or service model, application association, tag(s), and/or version(s) information.

Such information, and related information, including enhancement event, correlated metrics, automation, and topology may be used to train a change detection query model 418, which may be stored in a model repository 419. For example, related training information may include entity and/or node details, topology information, enhancement event time range, KPI threshold and pattern, and key-causal metrics and patterns.

Any information related to the change (e.g., automation event) associated with the enhancement event within a defined time range and for a corresponding monitored entity may be retrieved and stored 420, e.g., based on entity information and topology information. In some cases, an enhancement event may be validated as occurring (e.g., meets an enhancement threshold and is correlated with a key-causal metric) without being explicitly or definitively associated with an automation event. In such cases, it is possible to receive a specified automation event that is manually input 422. In such cases, the change detection query model may be retrained to be able to identify such automation events correctly in the future.

FIG. 5 is a first graph illustrating an example performance improvement indicating a candidate enhancement event. FIG. 6 is a second graph illustrating an example performance improvement indicating a candidate enhancement event.

FIG. 5 illustrates a graph 502 showing percentage of CPU utilization over time. As shown, CPU utilization 504 is higher than CPU utilization 506 following a candidate enhancement event 508. Similarly, FIG. 6 illustrates a graph 602 showing quantity of memory utilization over time. As shown, memory utilization 604 is higher than memory utilization 606 following a candidate enhancement event 608.

Thus, FIGS. 5 and 6 illustrate that improvements may be detected by monitoring streams of metrics over time, where, as described above, such candidate enhancement events may be compared against a suitable enhancement threshold as part of validating the candidate enhancement events as actual enhancement events.

For example, an enhancement event threshold may be created for KPI metrics based on a weekly average considering weekly-daily seasonality. For example, a moving average may be determined as a moving average of a metric value percentage of metric data points.

For example, in such scenarios, the weekly average with daily seasonality of metric may be calculated. Results may be compared against the previous week. If the new average of the current week is less than the enhancement threshold for the KPI in question, then further steps for enhancement event correlation and validation may be implemented. Otherwise, the candidate enhancement event is discarded.

In the examples of FIGS. 5 and 6, the enhancement events are each illustrated as occurring over a brief period of time, e.g., as an impulse improvement, but in other examples, enhancement events may occur over longer periods of time. For example, an average improvement may be calculated during a defined period of time following a potential automation event or change action.

FIGS. 7-9 illustrate graphs related to a first example candidate enhancement event. In FIG. 7, an example weekly performance baseline is shown in which graph parameters relate CPU utilization within a search cluster to a corresponding management policy that is implemented, such as an index state management policy. In other words, with reference to preceding description, a CPU utilization metric such as shown in FIG. 5 that demonstrates a candidate enhancement event may be correlated with, and validated against, a candidate cause of an automation event that includes an implementation of, or update to, an index state management policy.

Thus, the graph of FIG. 7 illustrates a previous week's data in which a document count 702 is approximately 20,000 for documents managed by a first management policy, with an associated query time 704 and CPU utilization metric 706. The graph of FIG. 7 is illustrated with weekly variation, demonstrating changes in measured quantities over the course of the preceding week.

FIG. 8 shows a graph similar to FIG. 7, but generated for a subsequent week after implementation of a second management policy. The new policy effectively reduces the management document count 802 from approximately 20,000 (702) to approximately 10,000 (802), with an associated reduction in CPU utilization metric 806 from the 706 utilization metric. For example, the new policy may implement a document cleanup function that results in the illustrated improvement to the CPU utilization metric 806.

Then, these changes may trigger use of appropriate modules and techniques described herein to determine a candidate enhancement event. Accordingly, the change in the utilization metric 706/806 may be calculated and compared against a corresponding enhancement threshold for that utilization metric.

A vector autoregression algorithm or other correlation algorithm may then be used to determine metric correlation of the utilization metric 806 with document count 802, where the utilization metric 806 may be previously classified as a key-causal metric. The utilization metric 806 may also be correlated with respect to query time 804, but may determine that no significant change is present.

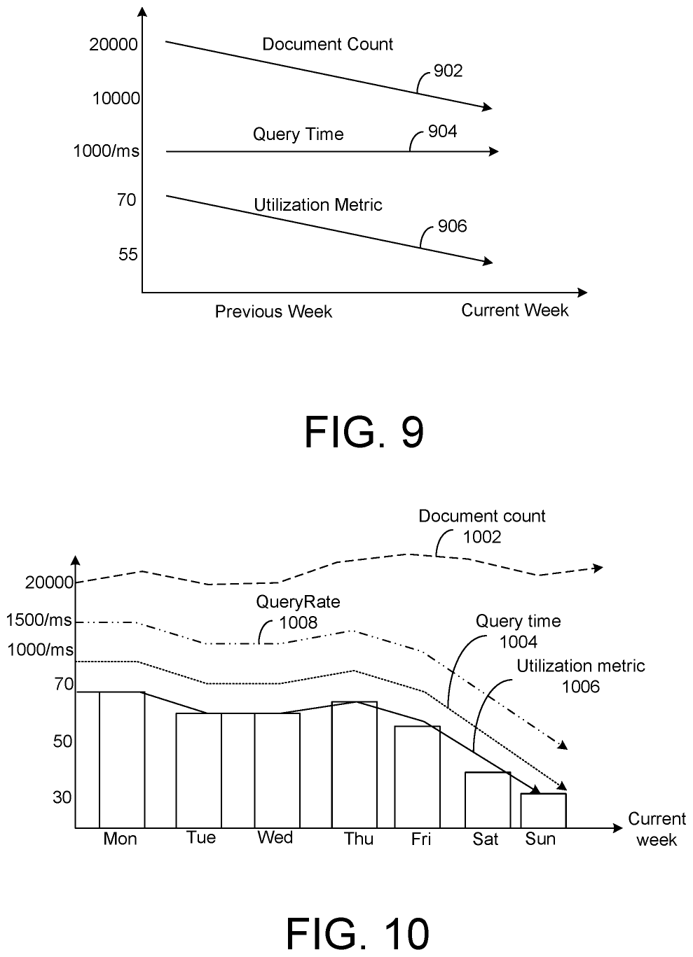

Results of the analysis performed with respect to FIGS. 7 and 8 are illustrated in FIG. 9. As shown, there is a direct correlation determined between a decrease in document count 902 (as a key-causal metric) and a decrease in CPU Utilization metric 906, with no decrease in query time 904. Thus, an enhancement event with respect to CPU utilization may be determined and correlated with a decrease in document account that is itself caused by a change event that includes installing a new index state management policy.

FIGS. 10-12 illustrate a counter example to FIGS. 7-9, in which a candidate enhancement event in a similar context is not validated as an actual enhancement event and is therefore discarded. In the example of FIG. 10, similar to FIG. 7, a document count 1002 is approximately 20,000, while a query time 1004 generally decreases from a value of about 1000/ms over the course of a preceding week. A utilization metric 1006 similarly decreases over the preceding week from a value of about 70 to a value of about 30. Meanwhile, a query rate 1008 decreases over the preceding week from a value of about 1500/ms.

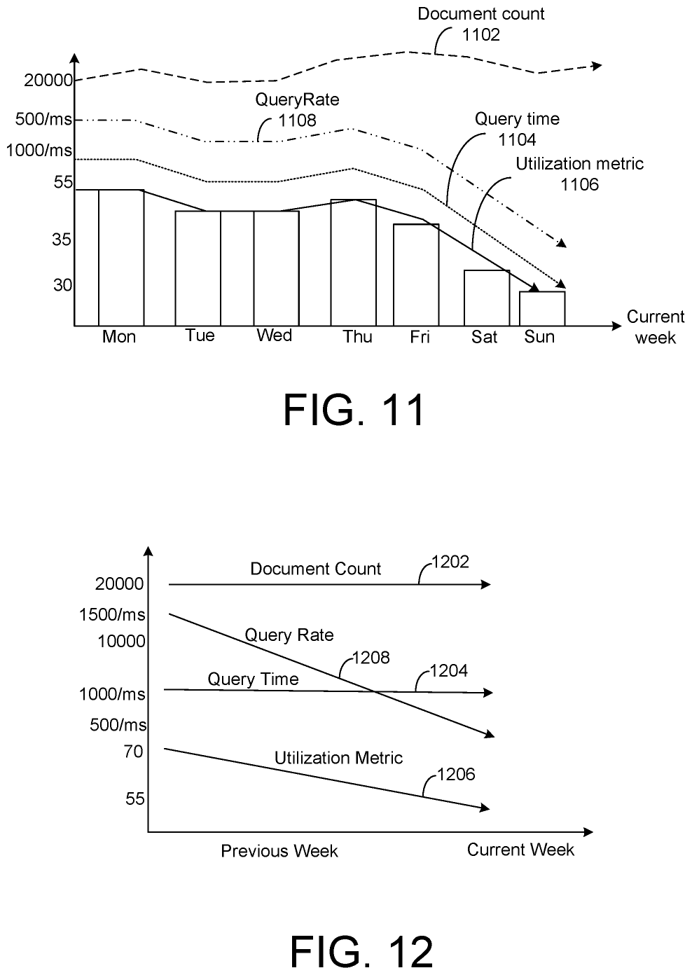

In the example of FIG. 11, similar to FIG. 8 and reflecting a week subsequent to the week represented in FIG. 10, a document count 1102 is approximately 20,000, while a query time 1104 generally decreases from a value of about 1000/ms over the course of a preceding week to a value of about 30. A utilization metric 1106 similarly decreases over the preceding week from a value of about 55 to a value of about 30. A query rate 1108 decreases over the week from a value of about 500/ms.

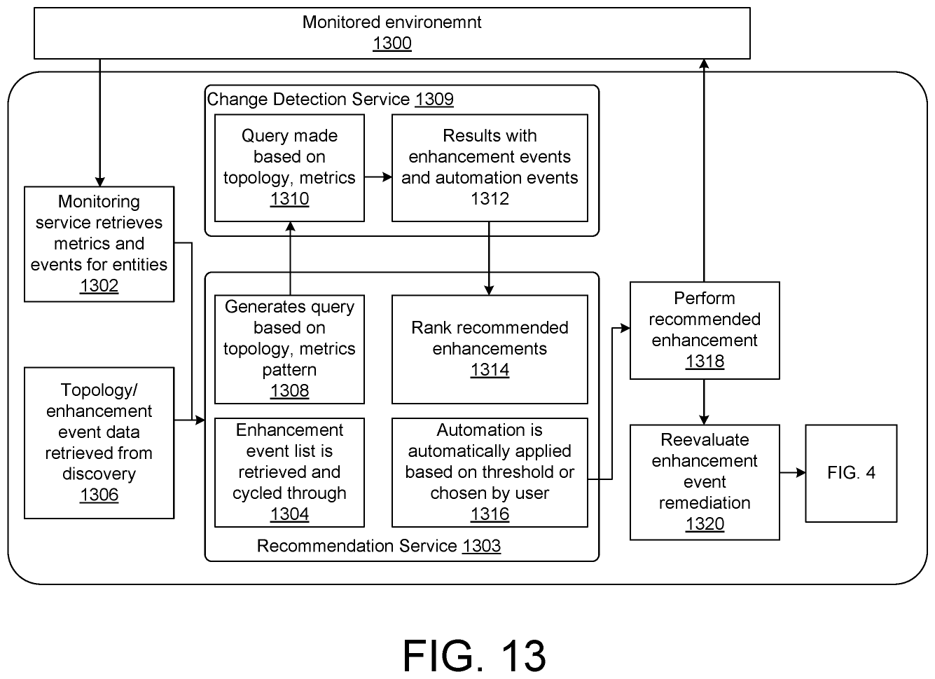

Thus, FIG. 12 illustrates that the scenario of FIGS. 10 and 11 represents a false positive scenario for a candidate enhancement event related to a CPU utilization metric. In particular, as shown in FIG. 12, document count 1202 and query time 1204 remain approximately constant, while a query rate 1208 decreases in conjunction with utilization metric 1206.

In other words, FIGS. 10-12 illustrate a false positive scenario in which, similar to FIGS. 7-9, a CPU utilization metric demonstrates improvement beyond an enhancement threshold and thus represents a candidate enhancement event. However, the improvement is correlated (e.g., using vector autoregression) with a reduction in usage as demonstrated by the query rate 1208. Put another way, CPU utilization decreases simply because users are using the search system less frequently, rather than from any underlying automation event or other change event related to a configuration or implementation of the search system (e.g., a reduced load, as compared to a configuration change).

As a result, the metric of query rate may be identified or classified as a false causal metric. The candidate enhancement event may be discarded from further processing or validation.

FIG. 13 is a block diagram illustrating an example implementation for propagating performance enhancements to additional monitored systems. For purposes of FIG. 13, it is assumed that at least one enhancement event has been validated and is being used to determine recommendations for propagating the validated enhancement improvement to a different component(s)/system(s) in order to obtain the same or similar performance improvements there.

In FIG. 13, a monitored environment 1300 has metrics and related events for entities retrieved by a monitoring service 1302, across multiple systems and environments. Captured metrics may be classified as key-causal, either in general or with respect to specific entities.

A recommendation service 1303 may retrieve one or more enhancement events from an enhancement event list 1304, along with topology, enhancement event, and other relevant contextual data 1306. For example, data characterizing environments in which each enhancement event occurred may be retrieved. As part of this process, remaining environments in which each enhancement event has not yet been applied may be identified, which may be referred to herein as, e.g., a candidate system, candidate component, candidate environment, candidate topology, or similar. Relevant topology information for each such candidate environment may be retrieved through discovery, as well.

A query may then be generated based on the retrieved enhancement event and related topology and associated metrics 1308. The generated query may be passed to a change detection service 1309, where the query based on topology and metrics is made 1310 and may be executed.

The query may thus determine, e.g., whether and how the candidate topology is similar, including whether included nodes/relationships are similar, or whether the candidate topology is associated with a similar business definition (e.g., a business service model) or other characterization. The candidate topology may be considered with respect to similarity of deployed applications, infrastructure components, tags, tracked performance metrics, incoming rate of calls, correlated metrics, and any other factor(s) that may indicate a type or degree of similarity.

Results may thus be obtained from the change detection service 1309 for candidate topologies, components, systems, or environments, with associated enhancement events and potential automation events to be performed 1312. The resulting recommended enhancements may be ranked or otherwise rated or evaluated for implementation 1314. For example, the query results from the change detection service 1309 may provide information regarding candidate topology, utilization, causal metrics, and other metric data. Therefore, recommendations that are highly similar in most or all of these categories may be ranked more highly than recommendations that are only similar in one or few of the categories.

One or more thresholds may be set with respect to the ranked results. For examples, recommendations that exceed a defined recommendation threshold may have corresponding automation events and/or change requests applied 1316 within the recommended topology. In other examples, an administrator or other authorized user can determine whether to proceed with the recommended enhancement.

The recommended enhancement may then be performed 1318. Subsequently, the recommended topology that received the recommended enhancement may be evaluated with respect to performance enhancement obtained 1320. For example, the recommended topology receiving the recommended automation event may be evaluated using the system and methods of FIG. 4, e.g., similar to a newly discovered enhancement event (e.g., subjected to correlation and validation analyses).

FIG. 14 is a block diagram illustrating detailed example implementations of the systems and methods of FIGS. 1-13. In FIG. 14, an enhancement event KPI configuration module 1402 is configured to identify relevant and useful KPIs and types or categories of KPIs. The enhancement event KPI configuration module 1402 may be further configured with classifications of KPIs or types of KPIs as being either key-causal or false-causal with respect to enhancement events. KPIs may be configured or classified as desired for individual products or types of products.

KPIs may also be configured with respect to how enhancement thresholds should be calculated. For example, the examples of FIGS. 7-12 above gave examples in which KPIs were tracked using a weekly moving average with weekly-daily seasonality. In other examples, a monthly or daily moving average may be used, or no seasonality may be required. In other examples, KPI values may be tracked on an absolute basis, without using a moving average.

An enhancement event threshold generation module 1404 may be configured to determine, define, and detect an enhancement threshold for each designated KPI, e.g., using a trained model from an ML model store 1408. As described above, an enhancement threshold may be defined with respect to a percentage or absolute value of a defined improvement of a tracked metric from metric data streaming 1406. Each enhancement threshold may be defined with respect to a manner in which a corresponding KPI is configured and tracked based on the output of the enhancement event KPI configuration module 1402.

Enhancement event generation module 1410 may thus be configured to receive values from metric data streaming 1406 and corresponding enhancement threshold(s) from the enhancement event threshold generation module 1404 and determine a candidate enhancement event therefrom. An enhancement event metric correlation module 1412 may then correlate the metric(s) of the candidate enhancement event with candidate metrics that may be key-causal or false-causal metrics.

In the example of FIG. 14, the enhancement event metric correlation module 1412 may use an autoregression model from an ML model store 1414 to provide correlation with potentially causal metrics. The enhancement event metric correlation module 1412 may thus validate an enhancement event based on correlating a key-causal metric as having caused the enhancement event.

The validated enhancement event may be reported to a change detection service 1416, which has access to an IaC repository 1420 as an example of a source of system changes or automation events that have been implemented. The change detection service 1416 also has access to an ML model store 1418 that stores a change detection model relating metrics, topologies, automation events and/or changes, and enhancement events.

In a more specific example, with reference to FIG. 1, an enhancement event may be validated as having occurred in the system 105a of the technology landscape 104. Discovery data 1424 may be used to determine, for the system 105a, relevant metrics, automation events and/or changes, topology information related to the system 105a and the detected enhancement event.

The change detection service 1416 may then be configured to receive a query for candidate components or systems to which the same or similar enhancement event (e.g., underlying automation event or change) may be applied. The change detection service 1416 may use one or more corresponding models from the ML model store 1418 and discovery data 1424 to respond to the query with candidate components systems and related metrics and topologies.

Returned information related to relevant metrics may include pattern-matches, if any, between similarly configured KPIs in the candidate system. For example, one or more of the KPI weekly moving averages with weekly-daily seasonality of any of FIG. 5, 6, 7, or 10 may be found to occur in one or more candidate systems.

An enhancement event recommendation engine 1422 may be configured to receive outputs from the change detection service 1416 and generate recommended components and/or systems for application of automation events and/or changes underlying the detected enhancement event. For example, the change detection service 1416 may determine that the system 105b and various other candidate systems, not shown in FIG. 1 or 14, may correspond to varying degrees with the system 105a for purposes of achieving a similar enhancement event.

For example, the enhancement event recommendation engine 1422 may provide ranked recommendations based on a manner and/or extent to which candidate components and/or systems match the detected enhancement event. For example, ranked recommendation(s) 1426 may be assigned the highest recommendation based on a determined match between detected causal metrics performance data, KPI metric data pattern(s), and topology parameters. Ranked recommendation(s) 1428 may be assigned the second-highest recommendation based on a determined match between detected causal metrics performance data and topology parameters. Ranked recommendation(s) 1430 may be assigned the third-highest recommendation based on a determined match between detected topology parameters.

Of course, the examples of FIG. 14 are non-limiting, and additional or alternative factors and/or approach to ranking may be used when providing recommendations. For example, enhancement events that provide significant performance improvements, e.g., beyond a second enhancement threshold, may require fewer matches to recommend a candidate component and/or system than enhancement events that provided smaller performance improvements. In other examples, a ML model may be trained to predict a type or degree of improvement that might be expected when implementing an automation event or change in a new component system (e.g., when implementing a change from the system 105a that led to an enhancement there within the system 105b).

Once a determined change action is implemented in a second system, e.g., in the system 105b, additional actions may be taken. For example, the implemented action may be monitored to ensure that a similar enhancement is obtained in the second system 105b, and that no adverse effects occur. Additionally, adjustments may be made either to the enhancement threshold(s) and/or to anomaly detection thresholds associated with one or more related monitoring services.

As described herein, conventional monitoring solutions are focused on identifying issues or problems and resolving the same, which is fundamentally a reactive way of dealing with situations. IT teams are under tremendous pressure to improve on performance and scalability and reduce resolution times when there are issues within an environment.

Consequently, conventional systems fail to identify improvements in systems that relate to any planned or unplanned changes. Moreover, there are no known structured mechanisms to track planned or un-planned changes that result in improved system performance, and therefore no conventional approach to store such changes with associated information.

Conventional systems may share best practices, e.g., by writing a detailed document by an expert about findings and changes required. Such best practices, however, are a static document and miss any reference to the live system. In contrast, described techniques provide more complete and more relevant details, e.g., impact on other dependencies and other parameters' behaviours in response to implemented changes. Described techniques make it straightforward to recommend similar changes to similar systems with high levels of accuracy.

Additionally, a large portion of today's knowledge articles and runbooks are focused on remediation and are not focused on improvements on a component or system that is in a green state. With described techniques, even well-running components or systems can be improved, e.g., by comparing trend lines and overall topology, and by applying automation events and/or changes related to enhancement events.

Conventional event monitoring solutions may report issues or problems in the system. However, as described herein, there are many incidences where some planned or un-planned activities ended up boosting overall performance of system that are going unnoticed and staying local to the system. Described techniques enable such improvements to be identified, stored with all details, searched, and shared to other similar systems with ease.

Described techniques may identify such improvements in the system and tag them as enhancement events after providing a specified level of validation to ensure that underlying change(s) will have no adverse effect, e.g., in an overall system.

A resulting, validated enhancement event may thus include all relevant information and have complete context that can be easy to search and understood and enables replication of changes to other relevant environments to achieve similar improvements.

Described techniques provide an ability to identify and tag improvements in a monitored environment using correlation metrics to prove that a positive change has occurred. Additionally, described techniques track such improvements so that they can be applied to other similar environments.

Described techniques provide a system to store system improvements, runbooks, and automation with their proven results and related entity and/or topology information. Positive changes in conventional systems are stored in a variety of ways through dozens of written documents, tools, and automations. Described techniques provide a consolidated reference for all like environments. Described techniques further generate recommendations for enhancement events in similar environments based on topology and/or entity information and key and causal metrics.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
process a stream of performance metrics characterizing a first component within a first topology of a technology landscape;
detect an enhancement event in the stream of performance metrics;
determine that the enhancement event was caused by an action performed with respect to the first component within the first topology;
query a change detection service characterizing the technology landscape, using the first topology and the action;
receive, from the change detection service and in response to the query, a second topology of the technology landscape; and
implement the action with respect to a second component of the second topology.

2. The computer program product of claim 1, wherein the instructions, when executed, are further configured to cause the at least one computing device to:
process the stream of performance metrics including calculating a moving average of values of the performance metrics.

3. The computer program product of claim 1, wherein the instructions, when executed, are further configured to cause the at least one computing device to:
detect the enhancement event as exceeding an enhancement threshold.

4. The computer program product of claim 1, wherein the instructions, when executed, are further configured to cause the at least one computing device to:
process the enhancement event using a correlation algorithm to relate the enhancement event with at least one action preceding the enhancement event, the at least one action including the action.

5. The computer program product of claim 4, wherein the correlation algorithm includes a vector autoregression algorithm.

6. The computer program product of claim 1, wherein the instructions, when executed, are further configured to cause the at least one computing device to:
validate the enhancement event including determining that the action caused the enhancement event.

7. The computer program product of claim 1, wherein the change detection service utilizes a trained change detection machine learning model that relates topologies, actions and performance metrics.

8. The computer program product of claim 1, wherein the instructions, when executed, are further configured to cause the at least one computing device to:
identify a second stream of performance metrics associated with the second topology from the change detection service and in response to the query; and
implement the action with respect to the second component, based on the second stream of performance metrics.

9. The computer program product of claim 8, wherein the instructions, when executed, are further configured to cause the at least one computing device to:
relate the second stream of performance metrics to the stream of performance metrics, based on a similarity of patterns of performance metric values within the stream of performance metrics and the second stream of performance metrics.

10. The computer program product of claim 1, wherein the instructions, when executed, are further configured to cause the at least one computing device to:
receive a plurality of topologies from the change detection service, including the second topology, each topology of the plurality of topologies associated with corresponding performance metrics and corresponding components; and
generate a ranking of the corresponding components for receiving the action, based on a degree of correspondence between each topology of the plurality of topologies and the first topology, and based on a degree of correspondence between the stream of performance metrics and each of the corresponding performance metrics.

11. A computer-implemented method, the method comprising:
process a stream of performance metrics characterizing a first component within a first topology of a technology landscape;
detect an enhancement event in the stream of performance metrics;
determine that the enhancement event was caused by an action performed with respect to the first component within the first topology;
query a change detection service characterizing the technology landscape, using the first topology and the action;
receive, from the change detection service and in response to the query, a second topology of the technology landscape; and
implement the action with respect to a second component of the second topology.

12. The method of claim 11, further comprising:
processing the stream of performance metrics including calculating a moving average of values of the performance metrics.

13. The method of claim 11, further comprising:
detecting the enhancement event as exceeding an enhancement threshold.

14. The method of claim 11, further comprising:
processing the enhancement event using a correlation algorithm to relate the enhancement event with at least one action preceding the enhancement event, the at least one action including the action.

15. The method of claim 11, further comprising:
validating the enhancement event including determining that the action caused the enhancement event.

16. The method of claim 11, further comprising:
identifying a second stream of performance metrics associated with the second topology from the change detection service and in response to the query; and
implementing the action with respect to the second component, based on the second stream of performance metrics.

17. A system comprising:
at least one memory including instructions; and
at least one processor that is operably coupled to the at least one memory and that is arranged and configured to execute instructions that, when executed, cause the at least one processor to:
process a stream of performance metrics characterizing a first component within a first topology of a technology landscape;
detect an enhancement event in the stream of performance metrics;
determine that the enhancement event was caused by an action performed with respect to the first component within the first topology;
query a change detection service characterizing the technology landscape, using the first topology and the action;
receive, from the change detection service and in response to the query, a second topology of the technology landscape; and
implement the action with respect to a second component of the second topology.

18. The system of claim 17, wherein the instructions, when executed, are further configured to cause the at least one processor to:
process the stream of performance metrics including calculating a moving average of values of the performance metrics.

19. The system of claim 17, wherein the instructions, when executed, are further configured to cause the at least one processor to:
process the enhancement event using a correlation algorithm to relate the enhancement event with at least one action preceding the enhancement event, the at least one action including the action.

20. The system of claim 17, wherein the instructions, when executed, are further configured to cause the at least one processor to:
validate the enhancement event including determining that the action caused the enhancement event.
